(19) United States
(12) Patent Application Publication
(10) Pub. No.: US 2016/0036798 A1
(43) Pub. Date: Feb. 4, 2016

(54) SECURE MOBILE CONTACT SYSTEM (SMCS)

(71) Applicant: Mobile Search Security LLC, Harrison, NY (US)

(72) Inventors: Patrick F.X. Mulhearn, Rye, NY (US); Leo Martin Caproni, III, Huntington Beach, CA (US); Francis J. Hearn, JR., Harrison, NY (US)

(21) Appl. No.: 14/816,755

(22) Filed: Aug. 3, 2015

Related U.S. Application Data
(60) Provisional application No. 62/033,052, filed on Aug. 4, 2014.
(60) Provisional application No. 62/157,516, filed on May 6, 2015.

(51) Int. Cl. H04L 29/06; G06F 21/60

(52) U.S. Cl. CPC H04L 63/08; G06F 21/606

(57) ABSTRACT

A system for authenticating an identity of a user is disclosed. The system comprises a processor and a non-volatile storage medium comprising computer executable instructions to instruct the processor to receive an image file relating to the user, from a user device owned by the user; determine whether the image file matches stored image information ma database, wherein the stored image information is not an image file and contains identifying information about the image; and, if the image file matches the stored image information, allow the user to request an authentication message be sent to the user device, request that an authentication message be sent to a destination oilier than, the user device, or request that a message be sent to a third party whose message addressing information is unknown to the user.

### PRIORITY

This application claims the benefit of U.S. Provisional Application Ser. No. 62/033,052 filed Aug. 4, 2014, and U.S. Provisional Application Ser. No. 62/157,516, filed May 6, 2015, the disclosures of which are incorporated herein by reference.

### BACKGROUND OF THE INVENTION

Individuals have become increasingly concerned about their security and privacy when using digital networks. The number one consumer concern is identity theft and related fraudulent transactions. Second is personal data privacy. People want to be sure their personal information is secure. They want to have control over how personal data is used and to whom it is disclosed. Two pieces of personal information people most seek to protect axe their Social Security and mobile telephone numbers.

No centralized system exists to address these needs and meet the heightened level of security that consumers, regulators and businesses require. As illustrated throughout this application, the demand for an ubiquitous system to verify identity, authenticate transactions, protect individuals from identity theft and enhance mobile privacy, is pervasive. Consumers, regulators and businesses will benefit horn a service that meets this demand, sued as the present invention.

### SUMMARY OF THE INVENTION

In one aspect of the invention, a system for authenticating an identity of a user is disclosed. The system comprising a processor and a non-volatile storage medium comprising computer executable instructions to instruct the processor to: a) receive an image file relating to the user, from a user device owned by the user, b) determine whether the image file matches stored image information in a database, wherein the stored image information is not an image file and contains identifying information about the image; and c) if the image tile matches the stored image information, allow the user to i) request an authentication message be sent to the user device, ii) request that an authentication message he sent to a destination other than the user device, or iii) request that a message be sent to a third party whose message addressing information is unknown to the user.

In one aspect of the invention, the system further comprises the step of d) sending: the message to the third party from the authenticated user. In one aspect of the invention, the message includes an audio file. In one aspect of the invention, the audio file is a recorded message created by the user. In one aspect of the invention, the message can be sent to the third party only if there exists data related to the third party in the database. In one aspect of the invention, the message includes Identification informatics for the user, and wherein the identification information is added to the message without intervention from the user in the creation of the message.

In one aspect of the invention, the system of claim 2, further comprising the step of sending an opt-in message to the third party If the third party is not a registered user of the system, prior to delivering the message to the third party. In one aspect of the invention, the third party is able to respond to the message without revealing his contact information, and wherein the third party is able to block the user front sending future messages to the third party. In one aspect of the invention, a preference of the third party relating to whether to block the user or other users from sending messages is stored in a database.

In one aspect of the invention, if the image file matches the stored image information, the user is allowed to send a message to another user via an alias. In one aspect of the invention, the processor determines whether the image file matches the stored image information using a non-minutiae-matching algorithm. In one aspect of the invention, the processor is capable of determining whether the image file matches the stored image information despite the image file and the stored image information having been created with differing environmental factors.

One aspect of the invention further comprises computer executable instructions to instruct the processor to obtain information relating to a location of the user device, and computer executable instructions to instruct the processor to record a time at which a request for authentication is made. One aspect of the invention further comprises computer executable instructions to instruct the processor to receive destination information for delivery of the authentication message.

In one aspect of the invention a manner of contacting the third party is identified using data from more than one database controlled by more than one entity. One aspect of the invention further comprises computer executable instructions to instruct the processor to receive a request from a third party to authenticate the user, and to instruct the processor to send a request tor the image file to the user. In one aspect of the invention, the system is operational without regard to the manufacturer of the user device or the operating system running on the user device.

In one aspect of the invention, a method of registering a user for a system for authenticating the identity of the user is disclosed. The method comprises the steps of: a) receiving, from a user device, subject-identifying information relating to the user and device-identifying information: relaxing to the user device; b) using the subject-identifying information to query a database for further information relating to the user; c) creating a question relating to the further information; d) transmitting the question to the user device; e) receiving an answer from the user device; f) if the answer is correct, requesting an identifying image from the user device; g) receiving the identifying image, converting the identifying image to a stored image information format wherein the stored image information format is not an image file and contains identifying information about the image, and storing data corresponding to the identifying image in the stored image information format; and h) storing the subject-identifying information and the device-identifying information in association with the data corresponding to the identifying image.

In one aspect of the invention, the identifying image is a biometric security image. One aspect of the invention further comprises the step of i) requesting additional information to be stored in the database, wherein said additional information can only be released upon the successful transmission of an authentication message, in one aspect of the invention, the further information is extracted from more than one database controlled by more than one entity.

In one aspect of the invention, a system for authenticating an identity of a document or thing is disclosed. The system comprises a processor and a non-volatile storage medium comprising computer executable instructions to instruct the processor to: a) receive an image life of the document or thing from a device; b) determine whether the image file matches stored image information in a database, wherein the stored image information is not an image file; and e) if the image file matches the stored image information, send an authentication message to the device or third party.

### BRIEF DESCRIPTION OF THE DRAWINGS

FIG. 1 is a view of the entire system embodying the network utility, as well as the authentication and secure messaging services.

FIG. 2 is a view of a flow diagram explaining the registration process within the network utility.

FIG. 3 is a view of a flow diagram explaining the process for sending an authentication confirmation message to the network utility.

FIG. 4 is a view of a flow diagram explaining the process of generating an authentication request from the network utility user.

FIG. 5 is a view of a flow diagram explaining the process of generating an authentication request from a third party.

FIG. 6 is a view of a flow diagram explaining the process of sending a secure message.

FIG. 7 is a view of a flow diagram explaining the Opt-In/Opt-Out process.

FIG. 8 is a view of a How diagram explaining the process of responding to secure messages.

### DETAILED DESCRIPTION OF THE DRAWINGS

The present invention defines a system and method of incorporating, aggregating and administering large volumes of data and images from multiple sources through a centralized, secure, cloud-based platform for the facilitation of authenticated, privacy-protected and secure communication services (the “Secure Mobile Contact System” or “SMCS”).

As designed, the present invention will enable: a) verification and registration of a mobile user's identity; b) five factor authentication (mobile device, person, time, location and object—e.g., document, credit card, passport, driver's license, currency, etc.); c) secure messaging between a registered mobile user and any other mobile user in a privacy-protected way when contact information is unavailable.

The SMCS will be accessible by all mobile users in the United States and internationally. Its centralized technology is supported by overlapping user profile records and includes contemporary, knowledge-based authentication (“KBA”) as well as image agnostic, recognition capabilities.

The SMCS enables two new services to address individuals' security and privacy concerns. The first service enables individuals to authenticate themselves for financial, retail, government, healthcare, and other important personal transactions. This service also enables individuals to expressly authorize and control the use of their personally identifiable information (“PII”), including their Social Security numbers, on a transaction-by-transaction basis.

The second service enables an individual to be contacted via his or her mobile phone in a privacy-protected and controlled way, by people who do not know the individual's mobile phone number. The service protects the privacy of the individuals being contacted through a variety of means and does not disclose their mobile number to parties trying to reach them. Furthermore, the service requires the contacting party to disclose his or her name and mobile number to the Individual receiving the contact.

Both services put privacy and security interests first. Individuals can reassert control over the disclosure and use of their personal information. Individuals know the identity of anyone trying to contact them.

In one aspect, the services are provided through a mobile industry clearinghouse supported by wireless carriers to facilitate authenticated and privacy-protected communication services.

The SMCS platform incorporates contemporary knowledge-based authentication, image agnostic recognition technology, reference data horn overlapping user profile records and privacy-protected messaging.

The SMCS platform and services are accessed through a network utility (like messaging or voice mail) that can be pre-installed on phones or can be downloaded. Both, services can be used by anyone with a wireless device that has camera functionality and data (e.g., internet) access. The invention, in one aspect, works without regard to the identity of the user's equipment manufacturer, operating system developer, or wireless carrier.

### Authentication

The standard for authentication in the U.S. involves two factors—a physical, factor (e.g., credit card) and a knowledge factor (e.g., PIN). The SMCS expands the standard to 5 factors: 1) biometric recognition of the person; 2) identification of the phone or wireless device by serial number: 3) authentication of a document (if part of a transaction); 4) systemic confirmation of the time at which an authentication request is made; and, 5) systemic calculation of the location of the requestor through GPS.

The SMCS platform performs authentication on three levels. The first level is passive. The system automatically captures the user's name and device identification, as it records the time and location of the request.

The second level is active and requires the user's identity to be verified through knowledge-based, authentication. The system generates a series of questions (e.g., 3-5 questions) specifically relating to the user's personal history or past financial transactions, e.g., “Did you ever own one of the above listed cars?” Or, “Have you ever lived at one of the above addresses?” Or, “In what year was your Social Security number issued?”

The third level of authentication utilizes image agnostic recognition technology. “Image agnostic” refers to the technology's equal effectiveness with biometric or non-biometric images. Following successful completion of the knowledge-based authentication process, a user can register a biometric security image of their choosing—combining a unique physical image with a knowledge factor (only the registrant knows the image selected).

The recognition technology allows for a contemporaneous picture of the security image to be taken under widely variable lighting conditions—e.g., in a darkened room or in bright sunshine. Only a contemporary picture of the actual biometric image will grant access to the SMCS and allow authentication. As designed, the system will not authenticate a picture of a picture.

In one aspect, the recognition technology may employ non-minutiae matching algorithms, based on pattern recognition. These algorithms use a large portion of the image as a whole for user verification—that is, much more information than when working with individual points (minutiae)—which makes them very accurate. This means that their error rates (especially the false acceptance rate, which is by far the more important of the two) is much lower than in other systems.

The new matching technology is inherently immune to various image distortions and imperfections. This fact makes it possible to use less costly sensors without degrading the performance. The technology even allows “cross-matching”, i.e., matching a pattern entered through one scanner model against a database that has been produced using another model.

Another advantage of the image-agnostic recognition technology is its ease of use. In contrast with some other biometric products, in which the procedure of enrolling new users is very tedious, the matching technology of the present disclosure, in one aspect, requires nothing from the user but to submit the user's pattern in a single instance to the enrollment procedure. The system itself grabs the image, and everything else is done automatically. The whole processing takes, in comparison with password protection, less than a second.

### Privacy-Protected Messaging

To enable privacy-protected, secure messaging, the network utility provides an interactive response system to obtain inquiry criteria from the user and draws upon centralized, third party referential databases containing overlapping mobile user profile records plus subscriber identification data from mobile carriers to find the sought party. Utilizing these multiple sources increases the match rate exponentially. Furthermore, the system is designed to learn from each transaction, thereby enhancing its underlying information to enable improved match rates over time. The collective resource, combined with carrier data, will allow for proper identification of the vast majority of mobile users within a geographic region.

Once a user has been authenticated, and the individual he or she is seeking to contact has been found by the system, a privacy-protected, secure message can be sent. The SMCS' automated, interactive system prompts the user to provide a brief description of the message to be sent. The user has the option to record a voice message (e.g., a .wav file) that can be attached to the SMCS platform-generated message sent.

The SMCS provides the user with the opportunity to review the message, and apprises the user of any fee that may be charged, before the message is sent. If acceptable, the user will authorize the transmission of the message.

If the recipient has not previously opted into the SMCS, signifying the recipient's consent to receive secure messages, the system, prompts the recipient with, an opt-in message notifying the recipient that a specific identified person is trying to reach them for a generic reason (e.g., medical, personal, business or other). The recipient will see the sender's name, and a generic reason for the contact, but not the full message. The recipient is also provided with all necessary disclosures and instructions as to how to opt into the SMCS. The recipient will only have to opt into the system once, provided, they haven't opted out of the system between transactions. A consumer may freely opt out of the system at any time.

Once the recipient has opted into the SMCS, the recipient will receive the message with the additional user details (i.e., name, return mobile number and message). The recipient will have the option to call back or send a return message to the user with the recipient's number blocked or masked to protect the privacy of the recipient's contact information. The SMCS also provides the recipient with the ability to block all future secure messages from the contacting user.

### System Performance

The SMCS platform is designed for reliability, responsiveness, security and scalability. The clearinghouse is both cloud and server-based to provide redundancy. Image recognition response time is 4 seconds or less. The system will scale to whatever simultaneous transaction rate is required.

### System Architecture

As contemplated, the system integrates four technologies (network utility, basic identification retrieval, external referential databases and image agnostic recognition) to perform real-time user (individuals and institutions) authentication and secure, privacy-protected message functionality. Communication with the system can be done through internet connections, but to enhance security, a private and secure network can be utilized.

The network utility works like a mobile application that the customer will have installed on, or downloaded to, his or her wireless device. The network utility is the interface between the customer and the other components and supported services of the system.

The basic identification retrieval component provides search capabilities using first/last name, address and other qualifying data. These basic elements are used to search for and identify an individual and locate the carrier for the individual's mobile number in order to send a secure, privacy-protected message.

Administration of the basic identification retrieval component of the system will, at a minimum, require the following:

Maintenance of an SMS interface between the system and the mobile carriers, as the mobile carriers will send the actual, privacy-protected text to its customer;

Maintenance of the subscriber preferences database which tracks people/mobile numbers that opt-out of the service or block other people from contacting them;

Maintenance of an API (application programming interface) to the network utility;

Maintenance of an API to each external, referential database, as well as the mobile carriers;

Hosting of the server/middleware which provides voice recording for text messages; and,

Hosting of the server/middleware which allows a text recipient to receive and respond in messages anonymously.

External, referential databases are accessed by the system to provide the necessary authentication and secure messaging functionality. The first database/databases support the knowledge based authentication service, which is utilized during the registration process. The provider(s) of such service will maintain the API to the network utility. The other database/databases are used for the basic search functionality, referred to above, which is used to identify individuals and enable the contemplated secure messaging service.

Finally, the system also provides for the image-agnostic recognition to facilitate user authentication. The designated image (e.g., the palm) is used for registration and subsequent authenticated access to the network utility, described above. The provider of the recognition technology will maintain an API to the network utility.

Through the use of secure APIs, which are encoded and encrypted, the components of the SMCS are interlinked through direct, private connections, thereby enhancing the secure transmission of data.

### Usage-Identity Verification and Authentication

As stated, during the SMCS registration process, a mobile user is definitively identified using the first two levels of authentication. He or she then is required to register a biometric “security image” in order to access the system in the future, manage account preferences, verify identity, authenticate transactions, send secure messages, etc. The network utility enables the wireless device's camera to be employed by the user to record a series of, for example, pictures of the palm of either hand, which then becomes the user's security image.

The next time that user wishes to access SMCS services, all that is necessary is to open the network utility and, using the wireless device, take a contemporaneous picture of their palm for verification by the clearinghouse. The process is simple and most importantly, virtually instantaneous.

From them, a user can authenticate to the phone or to a third party like a financial institution or a merchant. In most instances, the third party will establish a “pointer” (a euphemistic word/number combination to substitute for a mobile contact number). For example, a merchant might instruct a buyer of a large purchase to authenticate himself or herself by sending a message through the SMCS clearinghouse to “Merchant 100.” The buyer taps the authentication icon in the SMCS utility and says: “send to Merchant 100.”The transaction should take approximately 4 seconds.

In another iteration, the user can choose to register on the SMCS by recording voice prints as a back-up registration tool. The voice recognition technology will be imbedded in the utility. Once registered, a user may gain access to the system by using voice commands that are matched with the pre-recorded voice prints stored in the SMCS. The analysis employed for voice recognition within the SMCS is virtually identical to the analysis done with the image agnostic recognition technology.

Social Security numbers and other PIT can be verified, registered and protected through the SMCS platform. During the registration process, individuals will input their personal information (first and last name; street address; zip code; and the last 4 digits of their Social Security number) on the utility on the wireless device. Individuals will be able to ask organizations to request permission to use the individuals' Social Security numbers, or other PII, on a transaction-by-transaction basis through the SMCS. Similarly, organizations will he able to ask individuals to verify their Social Security numbers, or other PII, on a transaction-by-transaction basis through the SMCS to protect, against individuals trying to commit fraud using stolen Social Security numbers, or other PII. For example, instead of asking for a Social Security number, or other PII, the third party can simply ask the user to have the authentication system send a message to the third party. Because, in one aspect of the invention, the message itself contains no identifying information, and merely the result that the user has been authenticated, there is no opportunity for a would-be identity thief to intercept the information.

Also, individuals will be able to request that institutions with whom they wish to deal are authenticated. Through the SMCS, institutions, and their employees or agents, can be authenticated on a transaction-by-transaction basis. In order to become authenticated, an institution will be required to provide unique, identifying Institutional information, such as government credentials or a matrix barcode, during the registration process with the SMCS. The institution can also choose to register certain of its employees or agents so that those individuals may be authenticated as being associated with the institution (e.g., repairman, deliveryman, etc.).

Once an institution is registered with the SMCS platform, an individual may request the institution be authenticated before proceeding with a transaction. If institutional authentication is required, the institution will initiate the authentication process either directly with the SMCS or through the utility on an employee's smartphone. Once the authentication request has been made, the SMCS will search its database to ascertain whether the institution, and/or its particular employee or agent, is registered with die SMCS and, if so, the SMCS will send the requesting individual an authentication message confirming the identity of the specific institution and/or its particular employee or agent. It should be noted that prior to the authentication request being made, the institution and individual may agree upon a specific pointer to the individual's smartphone for the authentication result to be sent.

If the institution, and/or its particular employee or agent, is not registered on the SMCS, the SMCS cannot verify the identity of the institution, and/or its particular employee or agent, and will so advise the requesting individual. The individual will decide, then, whether to proceed with the transaction.

For example, an institution may send an employee (e.g., a repairman or deliveryman) to someone's home. Before the homeowner allows that employee to enter the home, the homeowner can require that the employee authenticate himself as a current employee of the institution with whom the homeowner made the appointment. At that time, the employee can interface with the SMCS through the utility on his smartphone. Like any person authenticating himself the employee can take a picture of his security image (e.g., palm of either hand), input on the smartphone a specific institutional code (or scan an institutional barcode that is contained on, for example, his employee ID—the utility has the technological capability built in to scan and read the barcode presented) and send the request to the SMCS. The SMCS will search to verity that employee individually and, by utilizing the specific institutional code, will verify that that employee is registered as a current employee of the institution. Once verified, the SMCS will send an authentication text to the homeowner verifying that the employee is associated with the specific institution with whom the homeowner has engaged.

In one aspect, the presets invention can be used us a facility to verify identity and to authenticate documentation or transactions. Billions of transactions require identification each year, e.g., airline passenger trips in the U.S. (which approach one billion per year), banking, access to buildings, purchasing alcohol, federal social welfare programs, buying a firearm, accidents or moving traffic violations, voting, use of subscribed services, such as Netflix from a different location or device, etc. End users can require verification of identify from others by requesting a text through the SMCS Platform. This provides significant, new protection against fraud and abuse and, more security during in home service calls or reassurance in online dating situations.

Centralized recognition technology can also be an invaluable resource in the unfortunate circumstances of a missing child, a lost Alzheimer patient or pet. These fundamental needs can be met initially, free of charge and drive pervasive awareness and use. The platform's recognition technology is as effective with still images as it is analyzing video streams. For example, a lost child whose, image has been stored on the SMCS Platform could be matched/found should law enforcement provide publicly available video streams, etc.

A user could choose to store critical digitized documentation—such as a driver's license, passport, Social Security card, birth certificate, health care or auto insurance/registration card, etc.—on the SMCS Platform and have these documents accessible on demand in an authenticated, digitized form. Rather than merely storing an image, the third pasty examining the document knows from the authentication process (Level 3-image recognition) that the uploaded document is authentic.

Online merchants could require a credit/debit card user to confirm a transaction through an SMCS message, eliminating die possibility of fraud. Debit card holders could set daily limits on transactions so that amount could only he exceeded when authorized by then through the Platform, e.g., for minor children or other dependents. Social Security numbers can be “protected” where they can only be used in a transaction if released by the owner through the SMCS Platform. This would eliminate identity theft. The SMCS Platform would eliminate the need to actually transmit the identifying details to the third party, which itself would reduce opportunities for fraud. For example, instead of asking for a Social Security number, the third party can simply ask the user to have the authentication system send a message to the third party. Because, in one aspect of the invention, the message itself contains no identifying information, and merely the result that the user has been authenticated, there is no opportunity for a would be identity thief to intercept the information.

All variations of fraud and abuse could be controlled—food stamps, voting, gun control, software theft of services, tax fraud, security transactions, etc. The SMCS Platform could stifle the underground economy and become a new weapon in the war on terror with image protected currency and passports.

A non-governmental, ubiquitous, easy to use, instantaneous authentication facility will be levered in many unforeseen ways just as other mass technologies have been in the past. Persons having skill in the art will realize that the present invention can be adapted to use cases in addition to those illustrated herein.

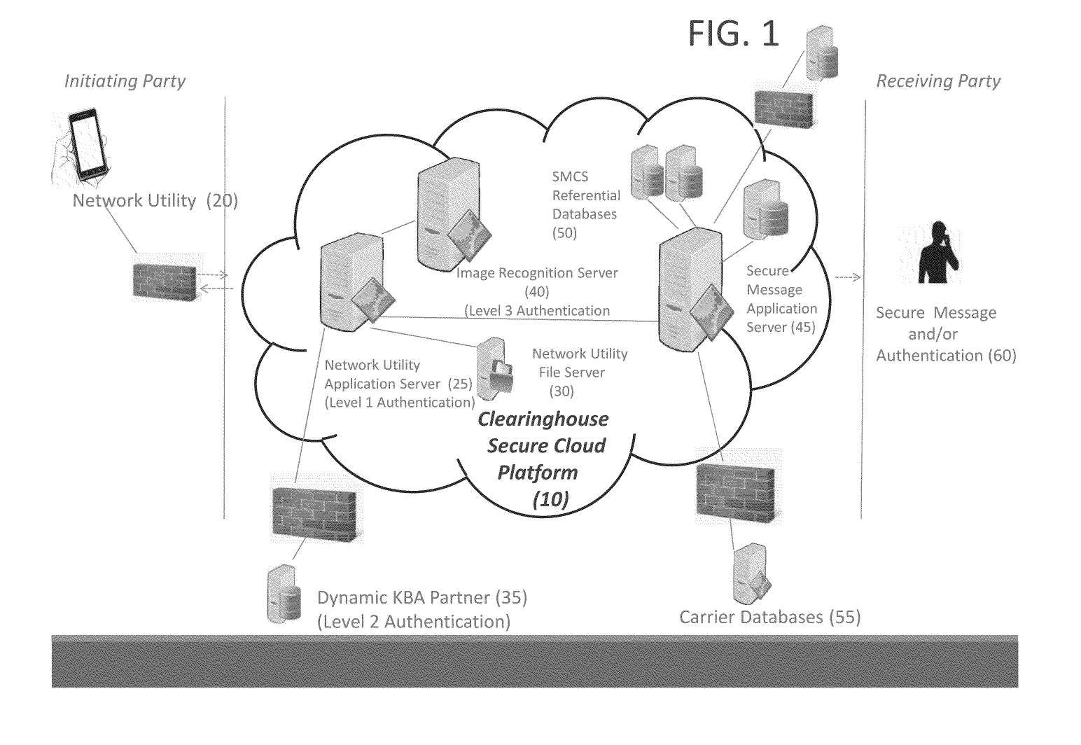

Referring now to FIG. 1, where like numerals refer to like elements, the SMCS includes a secure, centralized, cloud-based platform (10). In the first instance, the user will register with the SMCS. The SMCS platform is accessed through a network utility, which is pre-installed or can he downloaded onto the user's wireless device (20). In one aspect, the utility's underlying functionality is network-based rather than phone-based, much like the dial pad, voicemail or text messaging. However, persons having skill in the art will realize that the software for the utility can either be stored on the phone, on a remote network server, or any combination thereof.

To initiate the registration process, the user will access the SMCS through the Network Utility on their wireless device (20). The user will input his or her personal information (e.g., first and last name; street address; zip code; email address and the last 4 digits of their Social Security number) on the Network Utility (20). In one aspect of the invention, the Network Utility (20) is a software application for the wireless device.

The Network Utility (20), through a specific application programming interface (“API”), transmits this personal information, to the Network Utility Application Server (25). The Network Utility Application Server (25) stores the inputted data in the Network Utility File Server (30) within the SMCS platform (10) and transforms the inputted personal information to a recognizable format for the Dynamic KBA Partner's software and servers (35), maintained outside of the SMCS Platform (10), for review. The Network Utility Application Server (25) transmits the reformatted personal information through another specific API to the Dynamic KBA Partners software and servers (35). With that information received,, the Dynamic KBA Partner's software and servers (35) query publically available information contained in its databases and obtain a specific data set for the registering user. Based on the set of a predetermined, category of questions established by the SMCS, the Dynamic KBA Partner (35), utilizing its software and servers, queries publically available information in its databases for answers to the predetermined questions. When the questions and answers are received, the Dynamic KBA Partner's server (35) transmits the questions, through the specific API, to the Network Utility Application Server (25). The Network Utility Application Server (25) reformats the data and transmits the questions to the Network Utility (20).

The user is then provided with the series of multiple choice questions (e.g., 3-5) to establish subsequent user authentication. Persons having skill in the art will realize that fewer or more questions can he used. The user will provide answers to the questions and submit these answers back through the Network Utility (20) to the Network Utility Application Server (25). The user instructs the Network Utility (20) to transmit, the inputted answers to the questions to the SMCS Platform (10) by pressing an icon on the wireless device. Persons having skill in the art wall realize that there may he other features on a wireless device that can be used to direct the sending of information from the Network Utility (20) to the SMCS Platform (10). Within the SMCS Platform (10), the Network Utility Application Server (25) receives the information from the Network Utility (20), transforms the inputted data to a recognizable format for the Dynamic KBA Partners software and servers (35) and transmits such data to the Dynamic KBA Partner's software and servers (35). The Dynamic KBA Partner compares the inputted answers with the stored answers previously determined and stored by the Dynamic KBA Partner to establish whether the user's answers match the stored results. When there is a match, the positive authentication match result is transmitted back to the Network Utility Application Server (25) where a positive authentication message is generated to the user on the Network Utility (20). The positive KBA match result is stoma in the Network Utility File Server (30) for future reference. If there is no match, then the Dynamic KBA Partner will generate another set of predetermined questions and answers and the process will begin again.

Once authenticated through the KBA process, the user then will be asked to register a biometric security image (e.g., 4-5 pictures of the user's hand) for subsequent, further user authentication. The user will then transmit those images through the Network Utility (20) to the Network Utility Application Center (25) for storage and reference within the image Recognition File Server (40).

The servers ears be, in one aspect, general purpose computers equipped with redundant power supplies arid disk storage capabilities and are connected to the internet.

Once registered, the user may initiate a transaction using the Network Utility on the user's wireless device (20). The user will log on by submitting a picture of the same image as is stored in the Image Recognition File Server (40) within the SMCS Platform (10). The user will be authenticated by matching the submitted image with the user's stored security image.

Once authenticated, the Network Utility (20), will ask the user whether he or she would like to protect his or her PII. For example, the user's credit/debit cards (i.e., store the actual, numbers or pictures of the cards). Social Security number (or last 4 digits of the number), family members (i.e., biometric images of family members or pets who may go lost—Alzheimer patients or children) or other important documents such as a Driver's License, or Passport. If the user chooses to protect any such PII, the Network Utility (20) will prompt the user to input the specific data accordingly. Once completed, or if the user decided to not input PII at the time, the Network Utility (20) will ask the user whether he or she would like to authenticate themselves to their wireless device or to a third party, or send a secure message.

If the user desires to send an authentication message to their wireless device (20) or to a third party (60), the user will instruct the SMCS Platform (10) through the Network Utility (20) to send an authentication message to his or her wireless device (20) or to a designated third party (60).

If the user wants to send a Secure Message, then the user fills out the requested information (e.g., name and address, including city and state name, and age). When complete, the user transmits the information through the Network Utility (20) to the SMCS Platform (10). The Network Utility Application Server (25) within the SMCS Platform (10) receives the transmitted request and further relays the request to the Secure Message Application Server (45). The Secure Message Application Server (45) then searches its database for a match. The Secure Message Application Server (45) is continually updated, preferably on a daily basis, with data feeds from the SMCS Referential Databases (50), containing mobile user profiles obtained through publically available sources, and the telecommunication Carrier Databases (55), containing mobile subscriber account information. The Secure Message Application Server (45) transmits the match results to the Network Utility Application Server (25) which, in turn, transmits the match results to the Network Utility on the user's wireless device (20). Based on the data contained in the Network Utility File Server (30), the SMCS will be able to provide the user with additional identifying information such as alias names, previous addresses and other individuals associated with the searched for party—but not any mobile telephone number. The user will then choose from the match results the individual with whom they wish to contact and confirm that a Secure Message should be sent to that mobile user. The transmission of the Secure Message request goes from the Network Utility on the users wireless device (20) to the Network Utility Application Server (25) which, in turn, relays the instruction to the Secure Message Application Server (45). The Secure Message Application Server (45) searches its database to determine the end user's telecommunications carrier and sends that carrier the instruction to send the Secure Message to the Receiving Party (60). Once in receipt of the Secure Message instruction, the receiving carrier sends the Secure Message to the Receiving Party (60). In another aspect of the invention, the Secure Message Application Server (45) sends the Secure Message directly to the Receiving Party (60).

In order tor the Receiving Party (60) to receive the Secure Message, they have to had opted into the SMCS, signifying their consent to receive secure messages. If the Receiving Party (60) has not opted into the SMCS, the Receiving Party (60) will receive an opt-in message with notification that someone (e.g., an identified person) is trying to reach them. Once the Receiving Party (60) opts into the SMCS service, they receive the Secure Message with additional user details (e.g., name, return mobile number, and/or voicemail message from the user). The Receiving Party (60) will have an option to call back, or send a return message to the user with the Receiving Party's number blocked or marked to protect the privacy of the Receiving Party's contact information. The Receiving Party (60) will, also have an option, to block all future secure messages from the contacting user.

In one aspect of the invention, the opt-in status and consumer preferences (e.g., individuals instruction to block specific users from sending any SMCS Secure Message to them) will be stored in a specific database contained within the Secure Message Application Server (45).

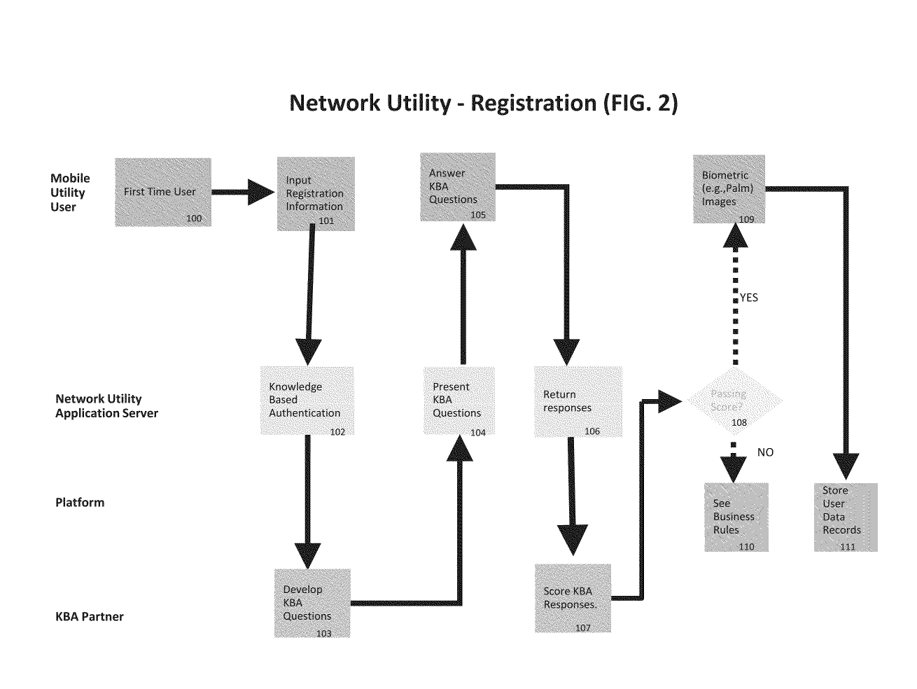

FIG. 2 displays a breakdown of the registration process within the Network Utility. The Mobile Utility User is a first time user (100). The Mobile Utility User inputs the appropriate registration information, consisting of First & Last Name, Address, Email, and last 4 digits of Social Security Number and, once completed, the user depresses the continue button (101). The Network Utility Application Server requests authentication data from KBA Partner after the user completes his or her initial data input (102).

The KBA partner generates multiple choice questions (e.g., 3-5) for the Mobile Utility User (103). The KBA questions are presented to the Mobile Utility User through the Network Utility Application Server (104). The Mobile Utility User responds to the KBA questions (105). The KBA responses are passed from the Network Utility Application Server to the KBA Parmer (106). The KBA. responses are scored, and the score is sent from the KBA Partner to the Network Utility Application Server (107).

Were the KBA responses correct? Yes=108; No=110. If incorrect, the Mobile Utility User is allowed a second attempt. Business rules will dictate what will happen in the event the second attempt fails. When the responses are correct, the Mobile Utility User will progress to the next step in the registration process, taking pictures (e.g., 3-5) of the designated security image (e.g., the palm of their hand) (109). Production system business rules would be followed if KBA (level 2 Authentication) answers were not correct after 2 attempts (110). The SMCS Platform will store the biometric images and registration information (111).

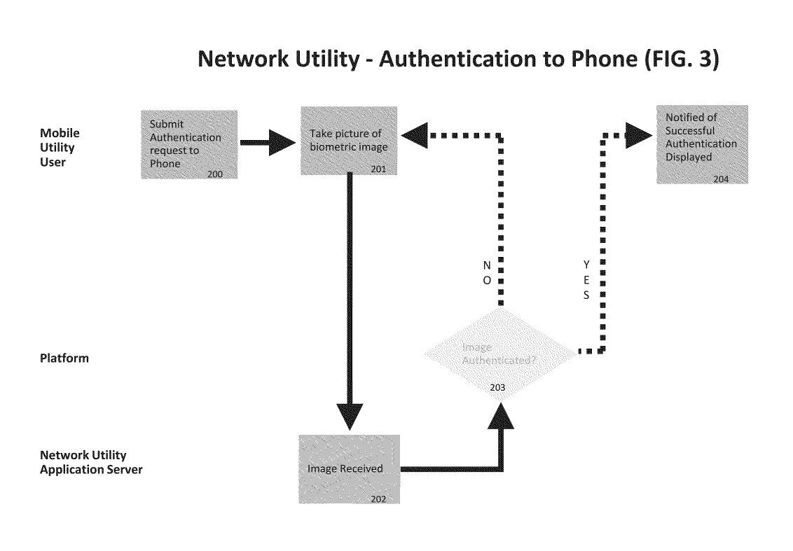

FIG. 3 displays the process tor sending an authentication confirmation message to the Network Utility on the wireless device. The Mobile Utility User initiates a request to authenticate to his or her wireless device (200). The Mobile Utility User takes his or her biometric image (if required due to time out) and submits it (201). The Network Utility Application Server receives the transmitted biometric image (202).

Was the image Authenticated (203)? Yes=204; No=201, and Mobile Utility User is asked to resubmit image. If the second image match fails, apply business rules.

The Mobile Utility User is notified of a successful authentication via the wireless device handset by displaying the user's name, address, time and location of authentication request (204).

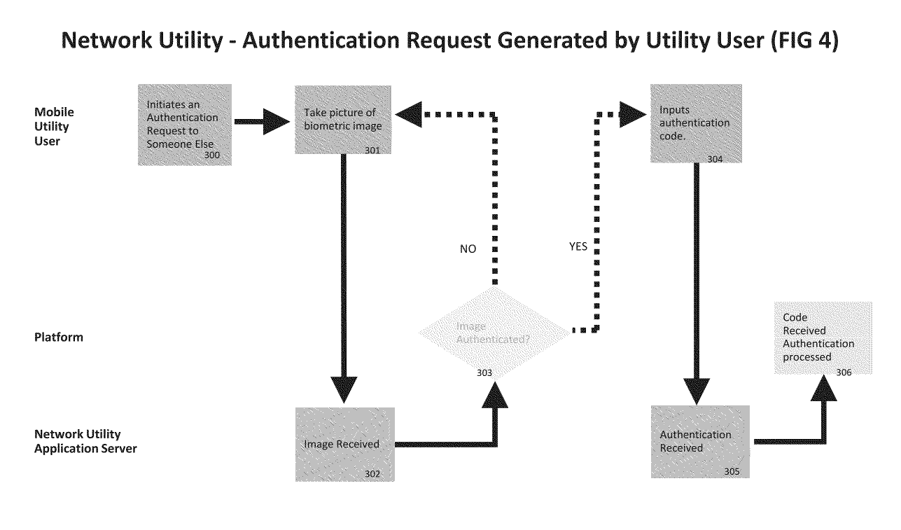

FIG. 4 displays the process for generating an authentication request from the network utility user. The Mobile Utility User initiates a request to authenticate to a third patty (300). The Mobile Utility User takes his or her biometric image (if required due to time out) and submits it (301). The Network Utility Application Server receives the transmitted biometric image (302).

Was the image Authenticated (303)? Yes=304, No=301 and the Mobile Utility User is asked to resubmit image. If the second image match fails, apply business rules. The Mobile Utility User is requested to input the third party's authentication code (e.g., 4 digit code) and submits it (304). The Network Utility Application Server receives the authentication code (305). The authentication, code is received, processed and a success message is sent to the Mobile Utility User (306).

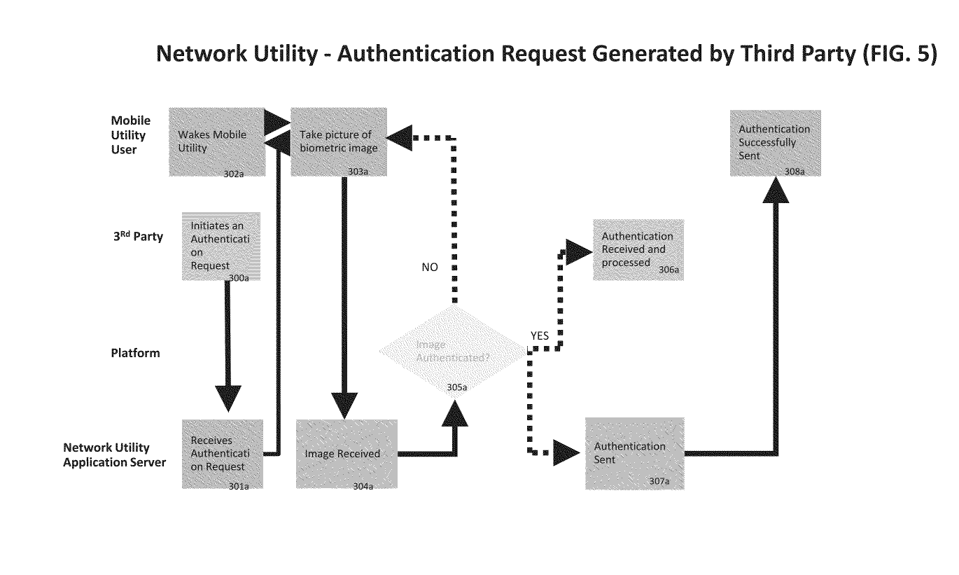

FIG. 5 displays the process of generating an authentication request from a third party. A third party Initiates an authentication request to a Mobile Utility User (300a). The Network Utility Application Server receives the authentication request (301a) and forwards the request to the Mobile Utility User. The Mobile Utility Users wireless device receives the request to authenticate, wakes the application and populates the “authenticate to a third party” screen with the third party's pointer address. If the wireless device cannot be awakened, then a push notification will be received instead (302a).

The Mobile Utility User will retake their biometric image (if required due to time out) and submit it (303a). The Network Utility Application Server receives the biometric image and third party pointer address and passes information to the SMCS Platform (304a).

Is the image authenticated (305a)? Yes=306a. No=303a and the Mobile Utility User is asked to resubmit image. If the second image match fails, apply business rules. The authentication code is received and processed (306a). The Network Utility Application Server is notified that the authentication message was sent to the third party and notifies Mobile Utility User (307a). The Mobile Utility User is notified that their authentication message was successfully sent (308a).

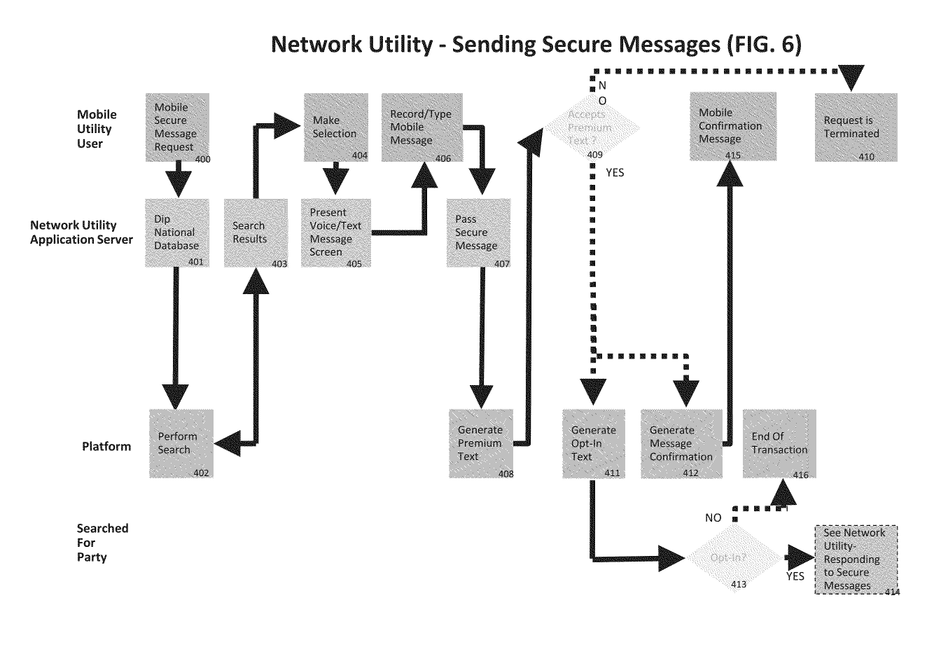

FIG. 6 displays the process of sending a Secure Message. The Mobile Utility User selects the “Send a Secure Message” option from the Home screen and is presented with a Search screen. The Mobile Utility User enters their query to locate the Searched For Party. Examples of the required fields tor the query are name and state; optional fields are city and age range (400). The Network Utility Application Server will parse the search request and search the platform (401). The platform performs a search of its national database (402). If there are several matches to the query, which requires further delineation, a ‘refine’ button will allow other qualifying data to be entered to refine the search. The Mobile Utility User will input more qualifiers and press the search icon (403). Once the appropriate record is located the Mobile Utility User will select the listing and press the ‘Continue’ icon (404).

The Mobile Utility User is presented with a semen that will allow the Mobile Utility User to type or record a message (405). The Mobile Utility User will, record or type the message that will be delivered and presses the send icon (406). The Network Utility Application Server passes the message to the SMCS Platform server for processing (407). The SMCS Platform sends a Premium Text message to the Mobile Utility User, and waits for approval response (408). Did the Mobile Utility User accept the Premium Text charge (409)? Yes=411 No=410. If Mobile Utility User does not accept the Premium Text charge, the request will be terminated (410).

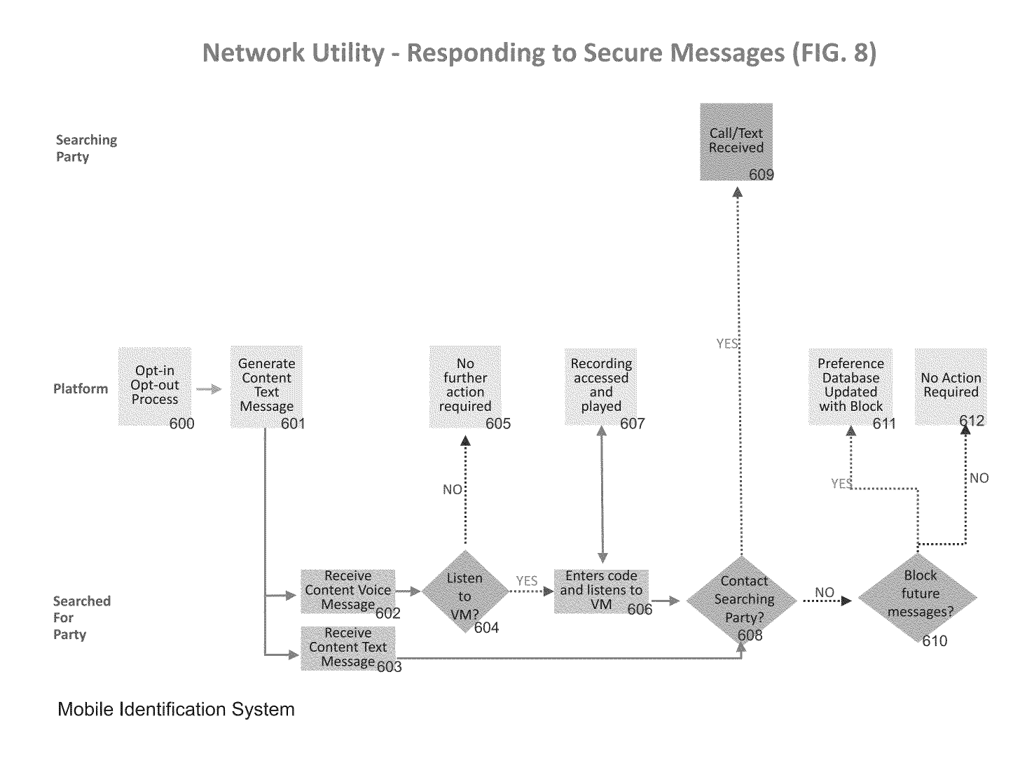

Once the SMCS Platform receives the Premium Text charge approval, an opt-in message is created and sent to the Searched For Party (411). Once the SMCS Platform receives the Premium Text charge approval, the SMCS Platform will send a confirmation message to the Mobile Utility User (412). Did the Searched For Party choose to opt-in (413)? Yes=414, No=416. If opt-in is accepted, see FIG. 8 (414). The confirmation message is delivered to the Mobile Utility User (415). If opt-in is rejected, the request has ended (416).

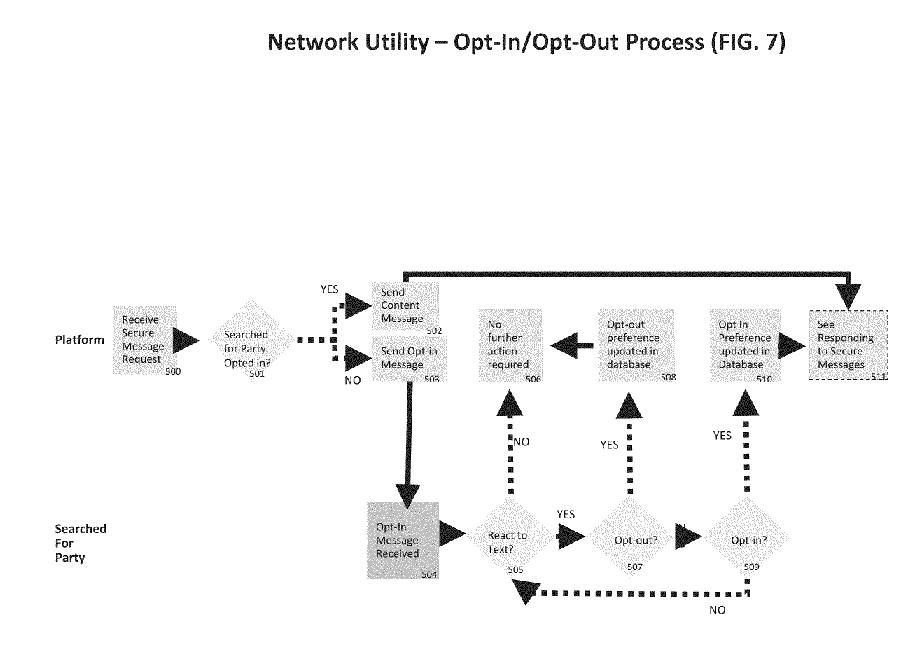

FIG. 7 displays the opt-in/opt-out process. The SMCS Platform receives a Secure Message Request (500). The SMCS Platform checks its preference databases to determine if the Searched For Party has already opted into the system (501). Yes=502 No=503. The SMCS Platform determines that the Searched For Party has previously opted into the system and sends the content message to the Searched For Party (502). The SMCS Platform determines that the Searched For Party has not previously opted into the system, and, therefore, sends the opt-in message to the Searched For Party (503). The Searched For Party receives the opt-in message (504). The Searched For Party determines whether or not to respond to the message (505). Yes=507 No=506. No further action required (506).

The Searched For Party determines whether or not to opt-out of the system (507). Yes=508 No=509. The SMCS Platform updates its database with the Searched For Party's preference as opted out of the system (508). The Searched For Party determines whether or not to opt-in to the system (509). Yes=510 No=505. The SMCS Platform updates its database with the Searched For Party's preference as opted out of the system (510). The SMCS Platform responds to the Secure Message (511)—See FIG. 8.

FIG. 8 displays the process for responding to Secure Messages. The opt-in/opt-out process is the starting point (600). The SMCS Platform generates a message to the Searched For Party. This message contains the following options:

RECORDED ANNOUNCEMENT

The recording is placed on a. secure HTTP address and is available to the Searched For Party to listen to tor a configurable amount of time. The Searched For Party will be sent a code (e.g., 4 digits) which, the Searched For Party will be required to enter to access the recording,

TEXT MESSAGE

The content message may be sent in the form of a text or SMS message.

RETURN CALL

To call back, the Searched For Party will have die following options;

Call directly from the mobile screen or by dialing from the keypad (understanding their telephone number will NOT be displayed to the Searching Party).

*67 can be dialed before entering the call back number to block the Searched For Party's number from appearing on the Searching Party's phone.

BLOCK MESSAGES

Future messages from the specific Searching Partying can be blocked by:

Click on the provided link.

Text reply “Block” to the message.

After the expiration of the recorded announcement and/or the text privacy option; if the Searched For Party attempts to use these options, they will be instructed of the expiration of such function. In the case of the recorded announcement, the Searched For Party will no longer be able to listen to the message (601).

The Searched For Party receives the content message with a link to the voicemail (602). The Searched For Party receives the content message as a text message (603). The Searched For Party determines whether or not to listen to the voicemail (604). Yes=606; No=605. No further action required (605). The Searched For Party enters a code to listen to the voicemail. The security code will be provided to the Searched For Party with the Secure Message (606). The SMCS Platform accesses the recording and plays the recording to the Searched For Party (607). The Searched For Party decides whether to call or text back the Searching Party (608). Yes=609; No=610. The Searching Party receives either an anonymous call back or text message with the originating number masked from the Searched for Party (609). The Searched For Party determines whether or not to block future messages from the Searching Party (610). Yes=611; No=612. The SMCS Platform updates its preference database blocking the Searched For Party's number from receiving future messages from the Searching Party (611). No further action required (612).

What is claimed is;

1. A system for authenticating an identity of a user, the system comprising a processor and a non-volatile storage medium comprising computer executable instructions to instruct the processor to:
a) Receive an image file relating to the user, from a user device owned by the user;
b) determine whether the image file matches stored image information in a database, wherein the stored image information is not an image file and contains identifying information about the image; and
c) if the image file matches the stored image information, allow the user to i) request an authentication message be sent to the user device, ii) request that an authentication message be sent to a destination other than the user device, or iii) request that a message be sent to a third party whose message addressing information is unknown to the user.

2. The system of claim 1, further comprising the step of d) sending the message to the third party from the authenticated user without disclosing the contact information of the third party.

3. The system of claim 2 wherein the message includes an audio file.

4. The system of claim 3 wherein the audio file is a recorded message created by the user.

5. The system of claim 2, wherein the message can be sent to the third party only if there exists data related to the third party in the database.

6. The system of claim 2, wherein the message includes identification information for the user, and wherein the identification information is added to the message without intervention from the user in the creation of the message.

7. The system of claim 2, further comprising the step of sending an opt-in message to the third party if the third party is not a registered user of the system, prior to delivering the message to the third party.

8. The system of claim 2, wherein the third party is able to respond to the message without disclosing his contact information, and wherein the third party is able to block the user from sending future messages to the third party.

9. The system of claim 8, wherein a preference of the third party relating to whether to block the user or other users from sending messages is stored in the database or in a second database.

10. The system of claim 1, wherein, if the image file matches the stored image information, the user is allowed to send a message to another user via an alias.

11. The system of claim 1, wherein the processor determines whether the image file matches the stored image information using a non-minutiae-matching algorithm.

12. The system of claim 11 wherein the processor is capable of determining whether the image file matches the stored image information despite the image file and the stored image information having been created with differing environmental factors.

13. The system of claim 1, further comprising computer executable instructions to instruct the processor to obtain information relating to a location of the user device, and computer executable instructions to instruct the processor to record a time at which a request for authentication is made.

14. The system of claim 1, further comprising computer executable instructions to instruct the processor to receive destination information for delivery of the authentication message.

15. The system ox claim 1, wherein a manner of contacting the third party is identified using data from more than one database controlled by more than one entity.

16. The system of claim 1, further comprising computer executable instructions to instruct the processor to receive a request from a third party to authenticate the user, and to instruct the processor to send a request for the image file to the user.

17. The system of claim 1, wherein the system is operational without regard to the manufacturer of the user device or the operating system running on the user device.

18. The system of claim 1, wherein if the linage file matches the stored image information, the user is also allowed to upload a second image file to be stored in the database or in a shared database, said system further comprising computer executable instructions instruction the processor to receive the second image, convert the second image to a stored image information format wherein the stored image information format is not an image file and contains identifying information about the image, and storing data corresponding to the second image in the stored image information format.

19. The system of claim 1, wherein if the image file matches the stored image information, the user is allowed to download a previously stored second image file, wherein data corresponding to the second image file is stored in the stored image information format and is converted to an image file.

20. A method of registering a user for a system for authenticating the identity of the user, comprising the steps of:
a) receiving, from a user device, subject-identifying information relating to the user and device-identifying information relating to the user device;
b) using the subject-identifying information to query a database for further information relating to the user;
c) creating a question relating to the further information;
d) transmitting the question to the user device;
e) receiving an answer from the user device;
f) if the answer is correct, requesting an identifying image from the user device;
g) receiving the identifying image, converting the identifying image to a stored image information format wherein, the stored image information format is not an image file and contains identifying information about the image, and storing data corresponding to the identifying image in the stored image information format; and
h) storing the subject-identifying information and the device-identifying information in association with the data corresponding to the identifying image.

21. The system of claim 20, wherein the identifying image is a biometric security image.

22. The system of claim 20, further comprising the step of i) requesting additional information to be stored in the database, wherein said additional information can only be released upon the successful transmission of an authentication message.

23. The system of claim 20, wherein the further information is extracted from more than one database controlled by more than one entity.

24. A system for authenticating an identity of a document or thing, the system comprising a processor and a non-volatile storage medium comprising computer executable instructions to instruct the processor to:
a) Receive an image file of the document or thing from a device;
b) determine whether the image file matches stored image information in a database, wherein the stored image information is not an image file; and
c) if the image file matches the stored image information, send an authentication message to the device or third party.

25. A method of registering a user for a system for authenticating the identity of the user, comprising the steps of:
d) receiving, from a user device, subject-identifying information relating to the user and device-identifying information relating to the user device;
e) using the subject-identifying information to query a database for further information relating to the user;
f) creating a question relating to the further information;
g) transmitting the question to the user device;
h) receiving an answer from the user device;
i) if the answer is correct, requesting audio containing a voice of the user from the user device;
j) receiving the audio and storing data corresponding to the audio; and
k) storing the subject-identifying information and the device-identifying information in association with the data corresponding to the audio.
